(19) United States
(12) Patent Application Publication
(10) Pub. No.: US 2009/0126414 A1
(43) Pub. Date: May 21, 2009

(54) FABRIC TREATING MACHINE

(76) Inventors: Jong Seok KIM, Seoul (KR); Dae Yun Park, Seoul (KR); Dong Won Kim, Seoul (KR); Sog Kie Hong, Seoul (KR)

Correspondence Address: KED & ASSOCIATES, LLP, P.O. Box 221200, Chantilly, VA, 20153-1200, US

(21) Appl. No.: 12/271,096

(22) Filed: Nov. 14, 2008

(30) Foreign Application Priority Data
Nov. 16, 2007 (KR) 10-2007-0117176

(51) Int. Cl. B08B 3/00

(52) U.S. Cl. 68/6

(57) ABSTRACT

A fabric treating machine is provided that removes odors, wrinkles, moisture and the like remaining in fabric articles by supplying steam and hot air flow into a receiving room in which the fabric articles are received. The steam may be provided evenly into the receiving room through a plurality of ports to minimize the discharge of condensed fluid into the receiving room. The fabric treating machine allows condensed fluid to be drained efficiently.

This application claims the benefit of the Patent Korean Application No. 10-2007-0117176, filed in Korea on Nov. 16, 2007, the entirety of which is incorporated herein by reference.

### BACKGROUND

1. Field

A fabric treating machine is provided, and in particular, a fabric treating machine that removes odors, wrinkles, moisture and the like from fabric articles using steam and hot air flow.

2. Background

Odors, wrinkles, moisture and the like often remain in fabric articles such as, for example, clothing, when the clothing is repeatedly worn or exposed to certain fumes or odors. In order to remove such odors, wrinkles and the like, a user may perform a washing function on the article, thus shortening an expected life span of the article and increasing the cost required to maintain. Also, wrinkles may remain in the article after washing and drying, requiring a separate ironing function or the like before the article can be used. A fabric treating machine that removes odors, wrinkles, moisture and the like from fabric articles without excessive washing, drying and ironing would be desirable.

### BRIEF DESCRIPTION OF THE DRAWINGS

The embodiments will be described in detail with reference to the following drawings in which like reference numerals refer to like elements wherein:

FIG. 1 is a perspective view of a fabric treating machine in accordance with an embodiment as broadly described herein;

FIG. 2 illustrates an interior of a machine room of the fabric treating machine shown in FIG. 1 and exemplary components housed therein; and

FIGS. 3A-3C illustrates various embodiments of a steam spraying device of the fabric treating machine as embodied and broadly described herein.

### DETAILED DESCRIPTION

In order to remove odors, wrinkles, moisture and the like from fabric articles, a fabric treating machine may spray steam onto the fabric articles and use hot air flow to dry the fabric articles that have been sprayed with steam. Although odors, wrinkles, moisture and the like may be significantly reduced by exposing the articles to air flow, moisture such as, for example, steam, may optimize the effects and provide for more complete elimination.

If steam is sprayed onto articles in the fabric treating machine, fine water particles may be coupled to odor/dirt particles remaining in the depth of fibers of the fabric, and the water particles coupled to the particles may be separated from the fabric during a drying process so as to remove odors therefrom.

However, during the process of supplying steam to the fabric articles received in the fabric treating machine, condensed fluid and the like may be discharged together with steam. If condensed fluid is discharged into a receiving room in which the fabric articles are received, it may make the drying process difficult.

Also, during the steam spraying process, foreign materials such as, for example, dust and the like, may flow into condensed fluid collected in a steam spraying device. It is undesirable to recirculate such contaminated fluid back into a steam supplying cycle. Also, condensed fluid that is instantly condensed during a stem discharging process may be at a high temperature, and thus energy may be wasted when the condensed fluid is instantly discharged.

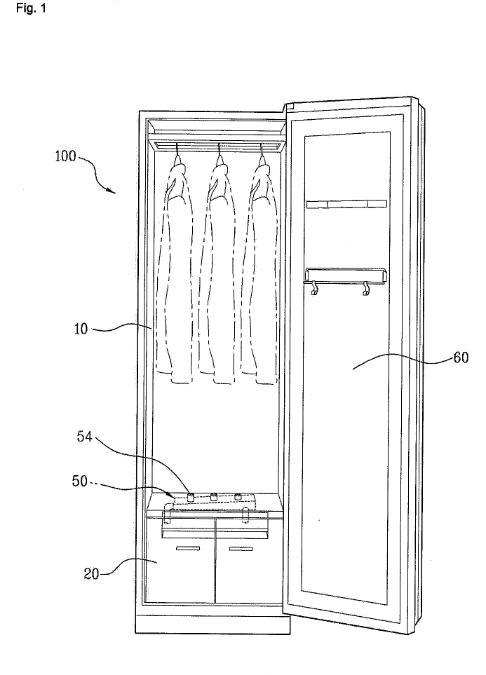

The fabric treating machine 100 shown in FIG. 1 may have a cabinet shape that forms a receiving room 10 which is opened and closed by a door 60. A machine room 20 provided below the receiving room 10 may house a steam generator (not shown in FIG. 1) that generates and supplies steam to the receiving room 10, and a heated air supply apparatus (not shown in FIG. 1) that supplies a hot flow of air to the receiving room 10.

Simply for ease of illustration and discussion, clothing articles are shown in the receiving room 10 of the exemplary embodiment shown in FIG. 1. However, other types of articles, such as, for example, bedding, table linens, draperies and other such articles which would benefit from the application of steam and/or heat, may be treated by a fabric treating machine as embodied and broadly described herein.

The steam generator may spray steam into the receiving room 10 through a steam spraying device 50 including a steam supplying port 51 connected to the steam generator and a plurality of steam outlets 54. The steam spraying device 50 sprays steam supplied from the steam generator (to be described later) provided inside the machine room 20, and receives or drains condensed fluid.

The steam supplied to the fabric articles in the receiving room 10 lessens wrinkles and the like remaining in the fabric articles. Wrinkles may be further lessened or eliminated by steam supplied during a drying process.

In the embodiment shown in FIG. 1, the steam spraying device 50 is provided at a lower portion of the receiving room 10. The plurality of steam outlets 54 may be substantially evenly spaced apart from each other, making it possible to evenly spray steam into the receiving room 10. Also, if the steam spraying device 50 is at the lower portion of the receiving room 10, steam may be supplied evenly to the fabric articles received therein, as the sprayed steam rises from the lower part to the upper part of the receiving room 10.

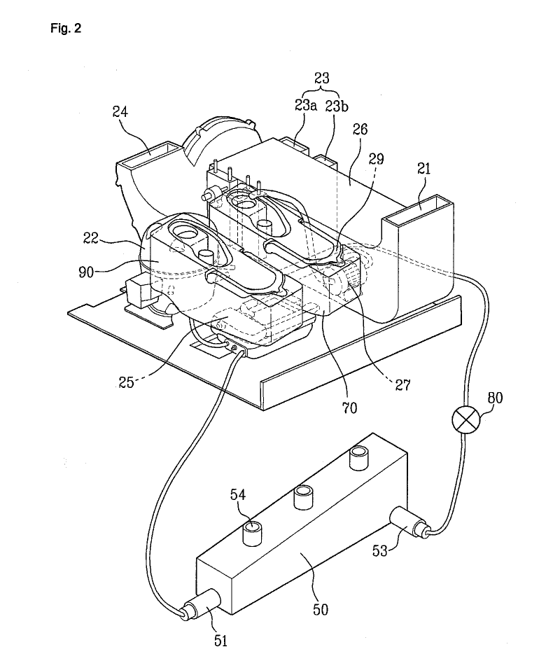

As shown in FIG. 2, the interior machine room 20 may house a steam generator 25 that generates and supplies steam to the receiving room 10, and a heated air supply apparatus that supplies hot air flow to the receiving room 10. The heated air supply apparatus may be, for example, a heat pump or an electric heater that heats dehumidified air. In either instance, the heated air supply apparatus may include a condensing part that condenses moisture of wet air drawn in through an inlet port 21, and a heating part that heats air that has been dehumidified in the condensing part. The heating part may be included with a heat exchanger of a heat pump, or an electric heater. Even when a heat pump is used for dehumidifying and heating wet air, a separate electric heater may be provided, in addition to the heat pump, to sufficiently heat the dehumidified air.

In the embodiment shown in FIG. 2, the heated air supply apparatus includes a compressor 22 that compresses refrigerant, a heat exchanger 23 that dehumidifies/heats air drawn in through an inlet port 21, and a circulation duct 26 that supplies the dehumidified and heated air through a blowing port 24. The blowing port 24 is an outlet of a blowing duct which may be formed integrally with a fan.

Air inside the receiving room 10 is drawn in through the inlet port 21, which is an entrance into the circulation duct 26, to be dehumidified or heated in the heat exchanger 23, and is then resupplied to the receiving room 10 through the blowing port 24.

A fabric treating machine that has a drying function may include a condensing type dryer or an exhausting type dryer. The embodiment shown in FIG. 2 is a circulating, which is not exhausted, but instead condenses and heats wet air and recirculates the air back into the receiving room 10. However, the steam spraying device 50 may also be applied to an exhausting type fabric treating machine. Therefore, air drawn in through the inlet port 21 is dehumidified in a condensing part 23b of the heat exchanger 23 and is heated in a heating part 23a thereof, and is then re-supplied to the receiving room 10 through the blowing port 24 to dry the received fabric articles.

The heat exchanger 23 dehumidifies wet air which has been circulated through the receiving room 10 during an evaporation process of refrigerant using refrigerant supplied from the compressor 22, and heats/reheats the dehumidified air through a condensation process. Compression of refrigerant may be conducted between the evaporation process and condensation process in the compressor 22 provided inside the machine room 20.

A drain part 70 may be provided in the machine room 20. Fluid condensed in the heat exchanger 23, the receiving room 10 and/or the steam spraying device 50 may be collected in a collecting part 29 located below the heat exchanger 23, such that waste collected in the collecting part 29 may be discharged through the drain part 70. In the embodiment shown in FIG. 2, the drain part 70 may be detachably installed in the machine room 20 so that the drain part 70 may be removed, emptied and replaced as necessary. In alternative embodiments, waste may be discharged directly through a waste line, without having a separate drain part. If the drain part is provided as part of an external sewer pipe, instead of in the detachable form, the fabric treating machine should be installed in proximity to an external sewer line. For ease of discussion and illustration, a drain part 70 having a detachable box form will be described.

Condensed fluid accumulated in the receiving room 10, the circulation duct 26 or the steam spraying device 50, and/or residual fluid in the steam generator 25 may be collected in the collecting part 29. The drain part 70 may be selectively separated from the machine room 20, taking capacity/shape/size and the like of the draining part 70 into consideration, making it possible to discharge waste contained therein. The movement of the waste from the collecting part 29 to the drain part 70 may be made using a drain pump 27 or the like.

If the drain part 70 can be positioned under the heat exchanger 23, the collecting part 29 may be eliminated. However, if the drain part 70 is to be detachable from the machine room 20, it may be advantageous to locate the drain part 70 at an upper part of the machine room 20 to facilitate removal and replacement. Thus, a pump 27 may be used to compensate for a difference in height/vertical position of these components.

When the drain part 70, a fluid supplying part 90 and the like are provided in a detachable form, they may be mounted on a drawer (not shown) that moves forward and backward into and out of the machine room 20. The waste may be delivered from the collecting part 29 to the drain part 70 using the drain pump 27 or the like, such that the collecting part 29 may be smaller in size than the drain part 70.

The steam generator 25 provided inside the machine room 20 generates steam by heating fluid supplied from the fluid supplying part 90. The fluid supplying part 90 may have a detachable box form similar to that of the drain part 70. The detachable fluid supplying part 90 may be used, as a relatively small amount of fluid is required to generate steam, and this allows the machine 100 to be installed in a place having no external fluid supply. However, when external supply facilities are readily available at a short distance, the fluid supplying part 90 may be replaced by the external supply.

In alternative embodiments the steam generator 25 may generate steam by heating a predetermined amount of fluid contained in a tank having a predetermined size and a built-in heater. However, any apparatus capable of generating steam may be used as the steam generator. For example, a heater may be installed directly on a circumferential surface of a supply hose, without storing fluid in a predetermined space. Other means for generating steam may also be appropriate.

The steam spraying device 50 may be connected to the steam generator 25, and also to the drain part 70 to recover the condensed fluid generated while steam inside the steam spraying device 50 is sprayed. The condensed fluid may be drained to the drain part 70 upon being generated. However, considering that the condensed fluid is at a relatively high temperature, the condensed fluid may remain in the steam spraying device 50 for a predetermined time so that it may be vaporized again, rather than allowing the condensed fluid to be drained as it is generated. Also, if the condensed fluid remains, space inside the steam spraying device 50 is reduced so that the supplied steam may be easily sprayed. And, the high temperature condensed fluid may help to keep the supplied steam warm.

In order to allow the condensed fluid to remain inside the steam spraying device 50, a valve 80 may be provided between a condensed fluid outlet 53 and the draining part 70. The valve 80 may interrupt the flow of condensed fluid from the condensed fluid outlet 53. The valve 80 may be, for example, an electronic valve controlled by a controller (not shown), or other type of valve as appropriate.

To control the valve 80, the steam generator 25 may include a fluid level sensor (not shown), and the steam generator 25 may be provided at a lower position than the steam spraying device 50. The valve 80 may be opened to drain fluid from inside the receiving room 10 to the collecting part 29 when a fluid level falling speed inside the steam generator 25 is slowed. When the condensed fluid flows backward to the steam generator 25 in a state where the valve 80 is closed, fluid inside the steam generator 25 is not normally consumed so that the fluid level falling speed may be slowed.

The fluid condensed in the steam spraying device 50 is not directly drained to the drain part 70 but first passes through the collecting part 29. If the condensed fluid is temporarily stored in the collecting part 29 and then is drained by the pump 27, the condensed fluid may be drained together with fluid condensed in the heat exchanger 23, thus simplifying the draining process and an internal structure of the machine room 20.

Movement of condensed fluid to the drain part 70 from the collecting part 29 may be facilitated by a pipe therebetween. The drain part 70 may be positioned at a higher position than the collecting part 29, and the compensation for the difference in height may be made by the pump 27.

A structure of a steam spraying device capable of allowing condensed fluid to remain inside the steam spraying device for a predetermined amount of time will now be described.

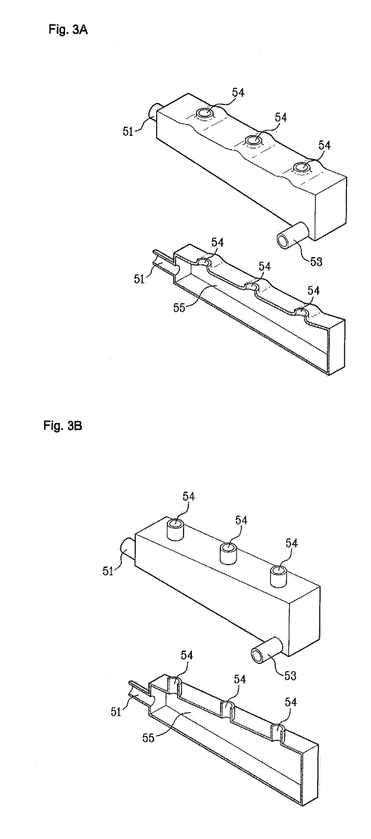

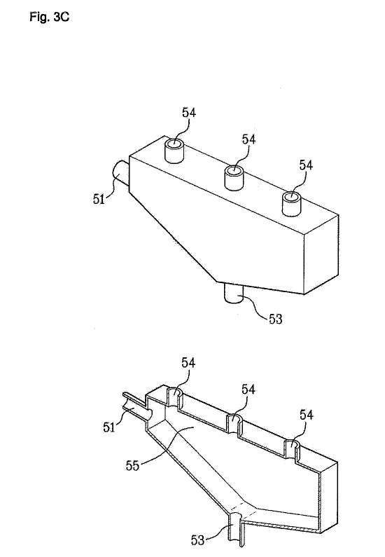

FIGS. 3A-3C are combined perspective and cross sectional views of various embodiments of a steam spraying device of a laundry treating machine as embodied and broadly described herein.

The steam spraying device 50 may be connected to the steam supplying apparatus 25 and the drain part 70, and may include a steam supplying port 51, a plurality of steam outlets 54, a condensed fluid receiving room 55 and a condensed fluid outlet 53.

The steam supplying port 51 is an inflow hole that receives steam supplied by the steam generator 25. The steam spraying device 50 may be connected to the steam generator 25 by a pipe, or other means as appropriate.

The steam spraying device 50 may have an elongated shape, and the plurality of steam outlets 54 may be spaced apart in a length direction along the steam spraying device 50 to supply steam evenly to the receiving room 10. The steam supplying port 51 may be formed at one end of the steam spraying device 50, and the steam outlets 54 may be formed as a series of branched pipes that extend through a bottom plate of the receiving room 10 to guide the direction of discharged steam.

Steam provided through the steam supplying port 51 is sprayed into the receiving room 10 through the plurality of steam outlets 54. Through this process, condensed fluid may be generated. As described above, it is preferable that condensed fluid not be discharged into the receiving room 10.

As shown in FIGS. 3A-3C, the condensed fluid receiving room 55 may be formed inside the steam spraying device 50. The condensed fluid receiving room 55 may receive fluid which is condensed while the steam supplied from the steam supplying port 51 is sprayed through the steam outlets 54.

The bottom inner wall surface of the condensed fluid receiving room 55 may be may extend at a downward incline from the steam supplying port 51 toward the condensed fluid outlet 53 so that condensed fluid may be easily received into the condensed fluid receiving room 55. Therefore, a sectional area of the end of the steam spraying device 50 at which the steam supplying port 51 is formed may be smaller than a sectional area of a portion thereof at which the condensed fluid outlet 53 is formed. Also, the steam supplying port 51 may be formed at a higher position than the condensed fluid outlet 53 to prevent condensed fluid from flowing backwards into the steam generator 25 through the steam supplying port 51.

The condensed fluid outlet 53 may be connected to a lower part of the condensed fluid receiving room 55. Although the valve 80 may control flow while steam is supplied to the receiving room 10, if the valve 80 is opened by the controller, condensed fluid may be drained from the condensed fluid receiving room 55 through the condensed fluid outlet 53. If the collecting part 29 is provided at a lower position than the condensed fluid outlet 53, and the valve 80 is opened, fluid inside the condensed fluid receiving room 55 may be drained to the collecting part 29.

As described above, although condensed fluid may be drained to the drain part 70 upon being generated, the steam is at a high temperature so that the condensed fluid remains in the steam spraying device 50 for a predetermined time rather than being drained as it is generated. However, if an amount of condensed fluid received in the condensed fluid receiving room 55 increases and temperature drops, it is unlikely to be vaporized into steam again, and the condensed fluid may be discharged into the receiving room 10, and the steam may be drained to the drain part 70 by opening the valve 80. Therefore, forming the condensed fluid outlet 53 on the lower part of the condensed receiving room 55 may facilitate the discharge of condensed fluid.

In a fabric treating machine as embodied and broadly described herein, in order to remove odors, wrinkles, moisture and the like remaining in received fabric articles, steam is sprayed, and hot air flow is supplied in order to dry fabric articles that have been wet by the sprayed steam, so that the odors, wrinkles, moisture and the like are removed by the supplied steam and hot air flow.

Also, in such a fabric treating machine, steam is evenly supplied to the fabric articles received inside the receiving room, making it possible to minimize heat loss of the steam supplied to the receiving room.

Also, in such a fabric treating machine, the amount of condensed fluid discharged into the inside of the receiving room can be reduced and the condensed fluid can be drained efficiently.

A laundry treating machine as embodied and broadly described herein may include a cabinet having a receiving room receiving laundry; a steam generator generating steam and supplying to the receiving room; a water collecting part collecting remain water of the steam generator or condensate water of steam; and a steam spraying unit including a steam supplying port connected to the steam generator, a plurality of steam outlets, a condensate water receiving room, and a condensate water outlet connected to the water collecting part connected to the steam generator and the water collecting part.

The laundry treating machine may also include a circulation duct provided in a space inside the cabinet partitioned from the receiving room, dehumidifying and heating air of the receiving room and resupplying it to the receiving room.

The condensate water of steam in the receiving room, the circulation duct, or the steam spraying unit and the remain water inside the steam generator may be collected in the water collecting part and wherein the steam spraying unit may discharge the condensate water inside the condensate water receiving room to the water collecting part through the condensate water outlet.

The condensate water receiving room may be formed below inside the steam spraying unit.

The steam supplying port may be provided at a higher position than the condensate water outlet.

The inner wall surface of the condensate water receiving room may be downwardly inclined toward the condensate water outlet.

The laundry treating machine may also include a valve capable of selectively interrupting the condensate water between the steam spraying unit and the water collecting part.

The steam spraying unit may be provided under a bottom surface of the receiving room and the steam outlets may be a plurality of pipes branched from the steam spraying unit.

The pipe type outlets may extend through the bottom plate of the receiving room.

The water collecting part may be positioned at a lower position than the condensate water outlet and condensate water in the receiving room may be drained to the water collecting part by opening the valve.

The steam spraying unit may have a tube shape and the plurality of steam spraying ports may be formed to be spaced in a length direction of the steam spraying unit.

A sectional area of the one end in a length direction of the steam spraying unit having the steam supplying port may be smaller than a sectional area of a portion formed with the condensate water outlet.

The steam supplying port may be formed at one end in a length direction of the steam spraying unit.

The steam generator may include a water level sensor and may be provided at a lower position than the steam spraying unit, the valve may be opened to drain water inside the condensate water receiving room to the water collecting part when water level falling speed inside the steam generator is slowed.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In additions to variations and modifications in the component parts and/or arrangements, alternative uses will also be apparent to those skilled in the art.

What is claimed is:

1. A fabric treating machine, comprising:
a cabinet having a receiving space formed therein;
a steam generator that generates steam and supplies the generated steam to the receiving space;
a collecting part that collects residual fluid remaining in the steam generator; and
a steam spraying device, including:
a steam supplying port connected to the steam generator;
a plurality of steam outlets;
a condensed fluid receiving room; and
a condensed fluid outlet connected to the collecting part.

2. The machine of claim 1, wherein the receiving space formed within the cabinet is partitioned by a partition wall into a first space which receives articles for treatment and a second space which receives the steam generator, the collecting part and the steam spraying device therein.

3. The machine of claim 2, wherein the first space is positioned above the second space, wherein the steam spraying device is coupled to a bottom surface of the partition wall such that the steam spraying device is positioned in the second space, and wherein the plurality of steam outlets comprise a plurality of pipes that extend through the partition wall into the first space.

4. The machine of claim 2, further comprising a circulation duct provided in the second space wherein the circulation duct receives recirculated air from the first space, dehumidifies and heats the recirculated air, and resupplies the dehumidified and heated air to the first space.

5. The machine of claim 4, wherein condensed fluid in the first space, the circulation duct and the steam spraying device, and residual fluid in the steam generator, are collected in the collecting part, and wherein the steam spraying device discharges condensed fluid accumulated therein to the collecting part through the condensed fluid outlet.

6. The machine of claim 2, further comprising a valve that selectively controls a flow of condensed fluid between the steam spraying device and the collecting part.

7. The machine of claim 6, wherein the collecting part is positioned at a lower position than the condensed fluid outlet such that condensed fluid accumulated in the first space is drained to the collecting part by opening the valve.

8. The machine of claim 6, wherein the steam generator is provided at a lower position than the steam spraying device, and wherein the valve is opened to drain fluid from the steam spraying device to the collecting part when a fluid level falling speed inside the steam generator is slowed.

9. The machine of claim 1, wherein a bottom inner surface of the condensed fluid receiving room extends at a downward incline from the steam supplying port toward the condensed fluid outlet.

10. The machine of claim 1, wherein the steam supplying port is provided at a higher position than the condensed fluid outlet.

11. The machine of claim 1, wherein the steam spraying device has an elongated shape and the plurality of steam outlets are arranged along a length direction of the steam spraying device, at predetermined intervals.

12. The machine of claim 1, wherein the steam supplying port is at a first end of the steam spraying device and the condensed fluid outlet is provided at a second end of the steam spraying device.

13. The machine of claim 12, wherein a sectional area of the first end of the steam spraying device is smaller than a sectional area of the second end of the steam supplying device.

14. A fabric treating machine, comprising:
a steam generator that generates steam; and
a steam spraying device that receives steam generated by the steam generator and sprays the received steam into a receiving space in which articles to be treated are received, wherein the steam spraying device comprises:
a housing that defines a receiving room;
a steam supply port provided at a first end of the housing, wherein the steam supply port is connected to the steam generator;
a plurality of steam outlets arranged along a longitudinal surface of the housing so as to spray steam into the receiving space; and
a condensed fluid outlet provided at a second end of the housing, wherein condensed fluid outlet discharges condensed fluid from the housing to a collecting part.

15. The machine of claim 14, wherein the second end of the housing is opposite the first end, and a bottom wall of the housing extends from the first end to the second end at a downward incline, with a sectional area of the first end being less than a sectional area of the second end.

16. The machine of claim 15, wherein the collecting part is positioned at a lower position than the condensed fluid outlet and the steam supply port is positioned at a higher position that the condensed fluid outlet.
